(19) United States
(12) Patent Application Publication
(10) Pub. No.: US 2012/0304101 A1
(43) Pub. Date: Nov. 29, 2012

(54) METHOD AND SYSTEM FOR DISPLAYING A DIGITAL BOOK

(75) Inventor: Ronald Dicke, Ottawa (CA)

(73) Assignee: SKYREADER MEDIA INC., Toronto (CA)

(21) Appl. No.: 13/302,397

(22) Filed: Nov. 22, 2011

Related U.S. Application Data
(60) Provisional application No. 61/416,036, filed on Nov. 22, 2010.

(51) Int. Cl. G06F 3/048

(52) U.S. Cl. 715/776

(57) ABSTRACT

A method for displaying digital book content comprises displaying to a user, via a display portion of an electronic display device, digital book content comprising first image data relating to a page of a digital book. The displayed digital book content comprise a predetermined region defining a virtual flap, the virtual flap being displayed within the predetermined region of the first image data in one of a closed state and an opened state. The user provides, via the electronic display device, an indication for selecting the virtual flap. In response to receiving the indication, second image data is displayed to the user via the display portion, the second image data relating to the page of the digital book and comprising a predetermined region defining the virtual flap.

### FIELD OF THE INVENTION

The instant invention relates generally to a method and system for displaying a digital book, and more particularly to a method and system for displaying digital book equivalents of lift-the-flap type books intended for young children.

### BACKGROUND OF THE INVENTION

Publishers of content traditionally offered on paper have started to digitize that content for distribution via electronic means. A digital book, which is also known as an electronic book or as an e-book, may be read on one of a personal computer, a personal digital assistant (PDA), a smart phone, etc., or on a dedicated hardware device known as an e-book reader or an e-book device. Digital books offer several advantages over conventional printed books. For instance: text can be searched automatically and cross-referenced using hyperlinks; font size and font type can be customized; non-permanent highlighting and annotation is supported; animated images or multimedia clips are supported; reading can resume automatically at the last read page, etc. In addition, a single e-book reader containing the text of several digital books is easier to carry around than the same books in printed form, and the backlit display of some e-book readers allows reading in low light or even in total darkness. Although they require electricity to be read, the production of digital books does not consume the paper, ink, and other resources that are used to produce printed books.

Unfortunately, there are a number of disadvantages associated with digital books as well. In particular, digital books often do not recreate entirely satisfactorily the familiar experience that is associated with reading a traditional printed book. This is especially true for certain types of books that are intended for young children, such as for instance lift-the-flap type books, in which a plurality of paper or cardboard flaps is integrated into the pages of the printed book. Typically, the upper side of each flap has a picture that is pertinent to a current page of the book. During reading, the flaps are lifted one at a time to reveal a picture on the back of the flap and/or to reveal a picture that is hidden underneath the flap. In this way, the illustrated content of each page of the lift-the-flap book can be changed as the story progresses. Of course, young children anticipate lifting each of the flaps to reveal the picture that is hidden below, and thus become more fully engaged in the story that is being told. Further advantageously, the act of lifting a physical flap also helps the young reader to improve his or her fine motor skills.

Digital books do not currently support displaying of images and/or animations, in addition to the text of the digital book, in a manner that approximates lifting a paper or cardboard flap in a printed lift-the-flap type book. It would be advantageous to provide a method and system that overcomes at least some of the limitations of the prior art.

### SUMMARY OF EMBODIMENTS OF THE INVENTION

In accordance with an aspect of the invention there is provided a1. A method comprising: providing an electronic display device comprising a display portion for displaying digital book content; displaying to a user, via the display portion, digital book content comprising first image data relating to a page of a digital book and comprising a predetermined region defining a virtual flap, the virtual flap being displayed within the predetermined region of the first image data in one of a closed state and an opened state; receiving from the user via the electronic display device an indication for selecting the virtual flap that is displayed within the predetermined region of the first image data; and, in response to receiving the indication, displaying to the user, via the display portion, second image data relating to the page of the digital book and comprising a predetermined region defining the virtual flap, the virtual flap being displayed within the predetermined region of the second image data in the other one of the closed state and the opened state.

In accordance with an aspect of the invention there is provided a method comprising: providing an electronic display device comprising a display portion for displaying digital book content; displaying to a user, via the display portion, digital book content comprising first image data relating to at least a portion of a page of a digital book, the at least the portion of the page of the digital book comprising a virtual flap; receiving from the user via the electronic display device an indication for selecting the virtual flap; and, in response to receiving the indication, replacing the display of the first image data with a display of predetermined second image data, wherein the first image data provides a visual representation of the virtual flap in a closed state and the predetermined second image data provides a visual representation of the virtual flap in an opened state.

In accordance with an aspect of the invention there is provided a method comprising: defining digital book content for being displayed to a user via a display portion of an electronic display device, the digital book content comprising a virtual flap; associating first image data and second image data with the defined digital book content, the first image data for providing a visual representation of the virtual flap in a closed state and the second image data for providing a visual representation of the virtual flap in an opened state; displaying the digital book content to the user via the display portion of the electronic display device, comprising displaying the first image data within a predetermined region of the digital book content; receiving from the user via the electronic display device an indication for selecting the virtual flap; and, in response to receiving the indication from the user, replacing the first image data displayed within the predetermined region of the digital book content with the second image data.

In accordance with an aspect of the invention there is provided a method comprising: providing an electronic display device comprising a display portion for displaying digital book content; providing to the electronic display device first image data relating to a first page of digital book content, the first image data for providing a first visual representation of a virtual flap within a predetermined region of the first page of digital book content, the virtual flap being visually represented in a closed state; providing to the electronic display device second image data relating to the first page of digital book content, the second image data for providing a second visual representation of the virtual flap within the predetermined region of the first page of digital book content, the virtual flap being visually represented in an opened state; using the electronic display device, displaying to a user via the display portion one of the first image data and the second image data; and, in response to receiving an indication from the user for selecting the virtual flap, displaying to the user via the display portion the other one of the first image data and the second image data.

In accordance with an aspect of the invention there is provided a method comprising: defining a page of digital book content comprising N virtual flaps, each one of the N virtual flaps having an opened state and a closed state; providing 2^{N} different page images relating to the defined page of digital book content, each one of the 2^{N} different page images for visually representing the page of digital book content with the N virtual flaps arranged in a different combination of opened and closed states; providing mapping data for switching between displaying a first page image of the 2^{N} page images and a second page image of the 2^{N} page images in response to a user selecting one of the N virtual flaps; displaying via a display portion of an electronic display device the first page image of the 2^{N} page images; receiving from a user via the electronic display device an indication for selecting the one of the N virtual flaps; and, based on the mapping data and the received indication, displaying the second page image of the 2^{N} page images via the display portion; wherein the selected one of the N virtual flaps is represented in one of the closed state and the open state in the first page image, and the selected one of the N virtual flaps is represented in the other one of the closed state and the open state in the second page image.

### BRIEF DESCRIPTION OF THE DRAWINGS

Exemplary embodiments of the invention will now be described in conjunction with the following drawings, in which:

FIG. 1a is a simplified diagram showing a page of a printed lift-the-flap type book having two flaps, with each one of the two flaps being in a closed state, according to the prior art;

FIG. 1b is a simplified diagram showing the page of FIG. 1a, with each one of the two flaps being in an opened state, according to the prior art;

FIG. 2a is a simplified diagram showing digital book content displayed via a display portion of an electronic display device, the digital book content including two virtual flaps, each virtual flap being defined within a predetermined region of the digital book content, and each virtual flap being visually represented in a closed state, according to an embodiment of the instant invention;

FIG. 2b is a simplified diagram showing the digital book content of FIG. 2a, with each virtual flap being visually represented in an opened state;

FIG. 2c is a simplified diagram showing the digital book content of FIG. 2a, including a plurality of second virtual flaps displayable in an opened state;

FIG. 3a is a simplified diagram showing digital book content displayed via a display portion of an electronic display device, the digital book content including two virtual flaps, each virtual flap being defined within a predetermined region of the digital book content, and each virtual flap being visually represented in a closed state, according to an embodiment of the instant invention;

FIG. 3b is a simplified diagram showing the digital book content of FIG. 3a, each virtual flap being visually represented in an opened state;

FIG. 4a is a simplified diagram of an electronic display device displaying first page image data relating to digital book content, and including a first virtual flap and a second virtual flap, each of the first and second virtual flaps being visually represented in a closed state, according to an embodiment of the instant invention;

FIG. 4b is a simplified diagram showing second page image data relating to the digital book content of FIG. 4a, the first virtual flap being visually represented in an opened state and the second virtual flap being visually represented in the closed state;

FIG. 4c is a simplified diagram showing third page image data relating to the digital book content of FIG. 4a, the second virtual flap being visually represented in an opened state and the second virtual flap being visually represented in the closed state;

FIG. 4d is a simplified diagram showing fourth page image data relating to the digital book content of FIG. 4a, each of the first and second virtual flaps being visually represented in the opened state;

FIG. 5 is a simplified diagram showing mapping data of page image data for a digital book page including two virtual flaps;

FIG. 6 is a simplified flow diagram of a method according to an embodiment of the instant invention;

FIG. 7 is a simplified flow diagram of a method according to another embodiment of the instant invention;

FIG. 8 is a simplified flow diagram of a method according to another embodiment of the instant invention;

FIG. 9 is a simplified flow diagram of a method according to another embodiment of the instant invention; and,

FIG. 10 is a simplified flow diagram of a method according to yet another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

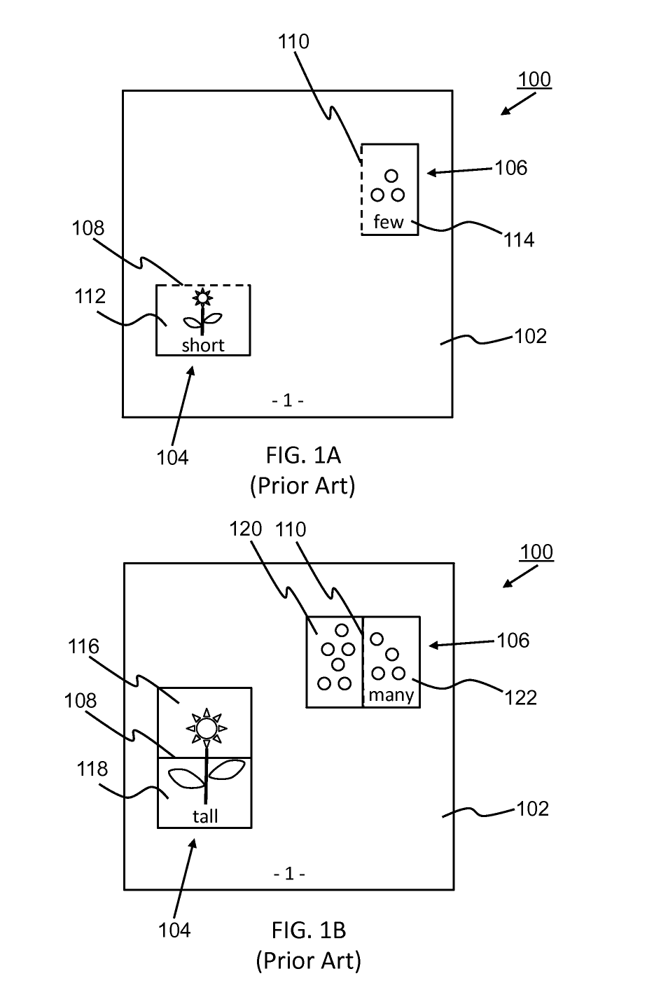

FIG. 1a is a simplified drawing showing a page 100 of a printed lift-the-flap type book having two flaps, with each one of the two flaps being shown in a closed state. In particular, the page 100 comprises a leaf of paper or cardboard material 102 with a first flap 104 and a second flap 106. The first flap 104 and the second flap 106 are movable between a closed state (shown in FIG. 1a) and an opened state (shown in FIG. 1b) by way of bending along the edges 108 and 110 of the first flap 104 and of the second flap 106, respectively.

Referring still to FIG. 1a, a picture is printed on the upper surfaces 112 and 114 of the first flap 104 and of the second flap 106, respectively. In this specific and non liming example, a picture of a short flower and the word “short” are presented on the upper surface 112 of the first flap 104, and a picture of three circles and the word “few” are shown on the upper surface 114 of the second flap 106.

Referring now to FIG. 1b, the page 100 of FIG. 1a is shown with the first flap 104 and with the second flap 106 in the open state. More particularly, the first flap 104 has been lifted about the edge 108 and the second flap 106 has been lifted about the edge 110. In the opened state a picture that is printed on the lower surface 116 of the first flap 104, and a picture that is printed in an area 118 of the page 102 that is beneath the first flap 104 when the first flap 104 is in the closed state, are revealed as a single coherent picture, which in this example is a tall flower and the word “tall.” Similarly, a picture that is printed on the lower surface 120 of the second flap 106, and a picture that is printed in an area 122 of the page 102 that is beneath the second flap 106 when the second flap 106 is in the closed state, are revealed as a single coherent picture, which in this example is ten circles and the word “many.” Optionally, only one of the first flap 104 and the second flap 106 is in the opened state.

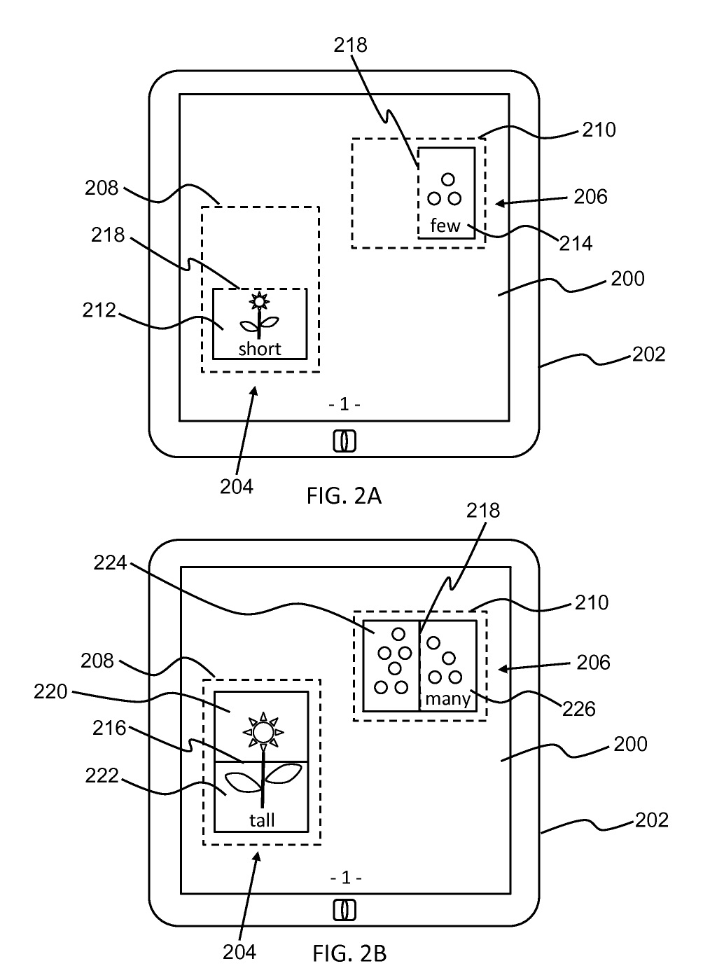

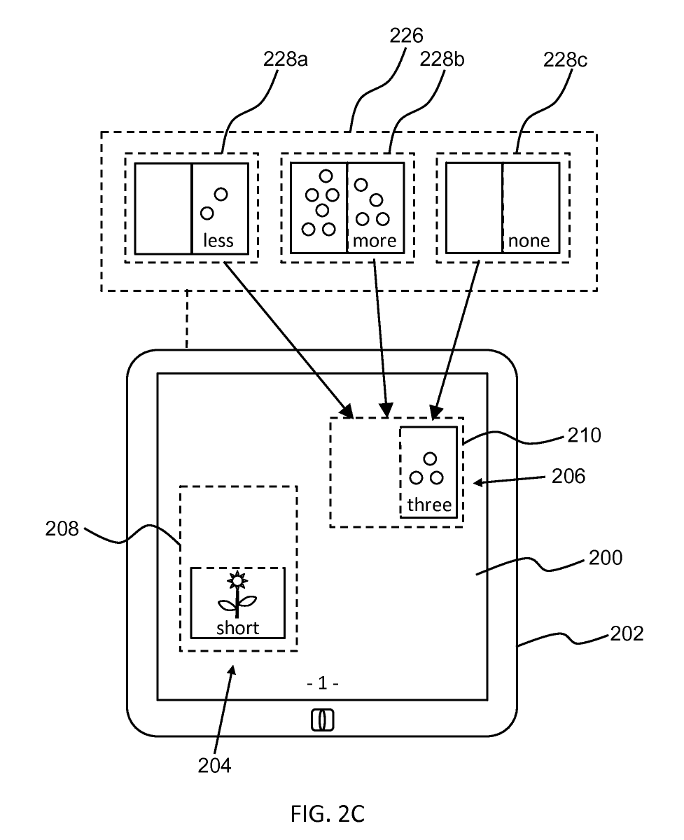

Referring now to FIG. 2a, shown is digital book content displayed via a display portion 200 of an electronic display device 202, the digital book content including a first virtual flap 204 and a second virtual flap 206. The first virtual flap 204 is displayable within a first predetermined region 208 of the digital book content and the second virtual flap 206 is displayable within a second predetermined region 210 of the digital book content. In FIG. 2a, the first virtual flap 204 and the second virtual flap 206 are both visually represented in a closed state. In the closed state, a virtual upper surface 212 of the first flap 204 and a virtual upper surface 214 of the second virtual flap 206 is displayed via the display portion 200 within the first predetermined region 208 of the digital book content and the second predetermined region 210 of the digital book content, respectively.

Referring still to FIG. 2a, each one of the first predetermined region 208 and the second predetermined region 210 occupies an area of the digital book content that is larger than a display area of a respective one of the upper surface 212 of the first virtual flap 204 and the upper surface 214 of the second virtual flap 206. One side 216 of the displayed upper surface 212 of the first virtual flap 204 and one side 218 of the displayed upper surface 214 of the second virtual flap 218 is disposed approximately within a middle section of the first and second predetermined regions 208 and 210, respectively. Referring now also to FIG. 2B, in the instant example the first and second predetermined regions 208 and 210, respectively, are sized approximately to accommodate the first and second virtual flaps 204 and 206, respectively, when said virtual flaps are displayed in an open state.

By way of a specific and non-limiting example, the display portion 200 of electronic display device 202 is a touch-sensitive screen. As is shown in FIG. 2A, during a first period of time first digital book content is displayed to a user via the touch-sensitive screen, wherein the first virtual flap 204 and the second virtual flap 206 are both visually represented in a respective closed state. The user provides an indication for selecting the first and second virtual flaps 204 and 206, respectively, such as for instance providing an input signal via the touch-sensitive screen of the electronic display device 202. For instance, the user touches the touch-sensitive screen within the first and second predetermined regions 208 and 210, respectively. Alternatively, the user makes a swiping, pinching or other suitable “multi-touch” gesture within and/or adjacent to the first and second predetermined regions 208 and 210, respectively. As is shown in FIG. 2B, in response to detecting the indication that is provided by the user, second digital book content is displayed to the user via the touch-sensitive screen, wherein the first virtual flap 204 and the second virtual flap 206 are both visually represented in a respective opened state. In this example, the user optionally selects the first and second virtual flaps 204 and 206, respectively, one at a time such that the second digital book content visually displays one of the virtual flaps 204 and 206 in a respective opened state and the other one of the virtual flaps 204 and 206 in a respective closed state.

In the example that is discussed with reference to FIGS. 2A and 2B, the step of displaying the second digital data via the display portion 200 comprises superimposing second digital data over the first digital data, within one or both of the first and second predetermined regions 208 and 210, respectively. For instance, in FIG. 2B second image data is displayed within the first predetermined region 208 that is visually representative of a portion of a picture that is “printed” on a virtual lower surface 220 of the first virtual flap 204, and that is visually representative of a portion of the picture that is “printed” in an area 222 of the digital book content that is “hidden beneath” the first flap 204 when the first flap 204 is in the closed state. As is shown in FIG. 2B, the portion of the picture that is “printed” on a virtual lower surface 220 of the first virtual flap 204 the portion of the picture that is “printed” in an area 222 of the digital book content that is “hidden beneath” the first flap 204 when the first flap 204 is in the closed state are presented as a single coherent picture, which in this example is a tall flower and the word “tall.” Similarly, the second image data is displayed within the second predetermined region 210 that is visually representative of a portion of a picture that is “printed” on a virtual lower surface 224 of the second virtual flap 206, and that is visually representative of a portion of the picture that is “printed” in an area 226 of the digital book content that is “hidden beneath” the second flap 206 when the second flap 206 is in the closed state. As is shown in FIG. 2B, the portion of the picture that is “printed” on a virtual lower surface 224 of the second virtual flap 206 the portion of the picture that is “printed” in an area 226 of the digital book content that is “hidden beneath” the second flap 206 when the second flap 206 is in the closed state are presented as a single coherent picture, which in this example is ten circles and the word “many.”

In an optional variation shown in FIG. 2C, a memory element 226 is provided in communication with electronic device 202 for storing a plurality of second digital data relating to at least one of the first virtual flap 204 and the second virtual flap 206 in the opened state. In the instant example, the first digital data that is displayed via display portion 200 includes a second virtual flap 206, shown in a closed state that is visually representative of three circles and the word “three.” Stored within memory element 226 is a plurality of second digital data 228a-c, each of which is visually representative of different second virtual flap content in an opened state. During use, a user provides an indication for selecting the second virtual flap 206, which in FIG. 2C is displayed within the second predetermined region 210 in a closed state. For instance, the display portion 200 is a touch-sensitive screen and the user provides the indication by touching or gesturing within the second predetermined region 210. In response to receiving the indication from the user, the electronic device 202 retrieves one of the second digital data 228a-c from the memory element 226. A visual representation of the second virtual flap 206 in an opened state corresponding to the retrieved one of the second digital data 228a-c is then superimposed within the second predetermined region 210. In this way, when the second virtual flap 206 is selected to be “opened,” the user will be presented with one of a plurality of different predetermined outcomes. In the instant example, the visual representation of the second virtual flap 206 in the opened condition is one of two circles and the word “less,” ten circles and the word “more” or no circles and the word “none.” Optionally, as in the instant example, each of the visual representation of the second virtual flap 206 in the opened condition is related to the visual representation of the second virtual flap 206 in the closed condition. Since the content that is revealed by “lifting” the second virtual flap 206 is variable, the user is likely to read the same book more often, and may also be provided with additional learning opportunities. Optionally, memory element 226 stores digital data for use in displaying to different users different virtual flaps in an opened state based on receiving an indication of the selection of a same virtual flap in a closed state. For instance, the virtual flaps that are displayed in the opened state have different themes in dependence upon the user's preferences, or visually present information that is appropriate given the user's age, etc. By way of a specific and non-limiting example, the opened flaps include Disney® Princess themed images when the user is female and Disney® Cars themed images when the user is male. Optionally, the flaps include words and/or numbers when the user is at least a predetermined age, but when the user is less than the predetermined age the flaps include images only.

Optionally, the memory element 226 is an internal or a removable memory element in communication with the electronic device 202, including a solid-state memory element, an optical disk or a proprietary cartridge etc. Alternatively, the memory element 226 is in communication with a remote server (not illustrated), and the second digital data 228a-c is provided from the remote server to the electronic device 202 via a wireless or wired communication channel.

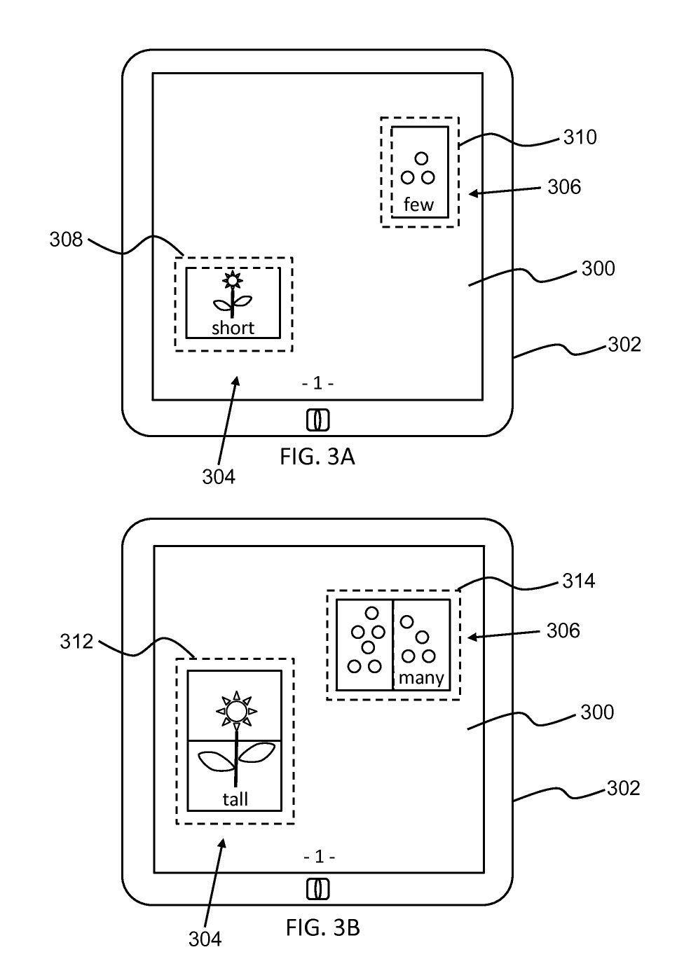

FIG. 3a is a simplified diagram showing digital book content comprising first digital data displayed via a display portion 300 of an electronic display device 302, the first digital data including first and second virtual flaps 304 and 306, respectively, each virtual flap 304 and 306 being defined within a predetermined region of the digital book content, and each virtual flap being visually represented in a closed state. As is shown in FIG. 3a, the first virtual flap 304 in the closed state is defined within a first predetermined region 308 that is dimensioned similarly to the first virtual flap 304 in the closed state. The second virtual flap 306 in the closed state is defined within a second predetermined region 310 that is dimensioned similarly to the second virtual flap 306 in the closed state. Referring now to FIG. 3B, shown is a simplified diagram showing digital book content subsequent to superimposing second digital data over the first digital data of FIG. 3A. In FIG. 3B, the first virtual flap 304 in the opened state is defined within a third predetermined region 312 that is dimensioned similarly to the first virtual flap 304 in the opened state. The second virtual flap 306 in the opened state is defined within a fourth predetermined region 312 that is dimensioned similarly to the second virtual flap 306 in the opened state. During use, greater fine motor control is required in order to select the first or second virtual flaps 304 and 306, respectively, in the closed state since the first and second predetermined regions 308 and 310 are dimensioned similarly to the flap image displayed therein. By dimensioning the first and second predetermined regions 308 and 310, respectively, to approximately correspond to the displayed limits of the first and second virtual flaps 304 and 306, respectively, in the closed states, it is possible to simulate an experience that is very close to the experience of using an actual lift-the-flap book.

Optionally, the second digital data includes an animation to simulate lifting of a selected one of the first and second virtual flaps 304 and 306, respectively. Further optionally, the second digital data replaces the first digital data instead of being superimposed on the first digital data. In this way, when one of the first and second virtual flaps 304 and 306 in the opened state is selected, the second digital data may be replaced with the first digital data, such that the selected one of the first and second virtual flaps 304 and 306 in the closed state is displayed within a respective predetermined region. Optionally, the first digital data includes an animation to simulate closing of a selected one of the first and second virtual flaps 304 and 306, respectively.

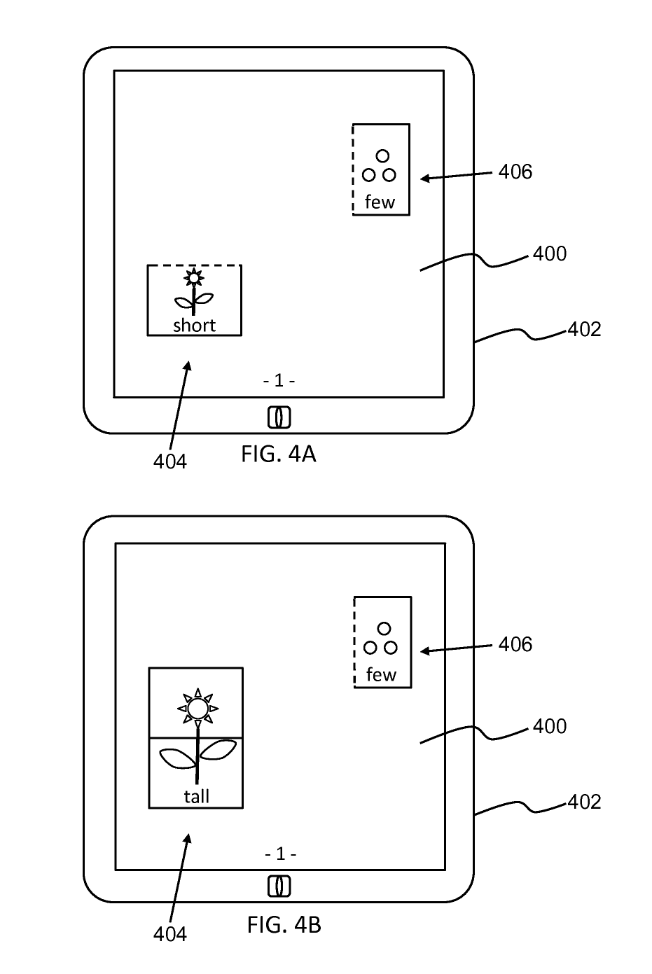

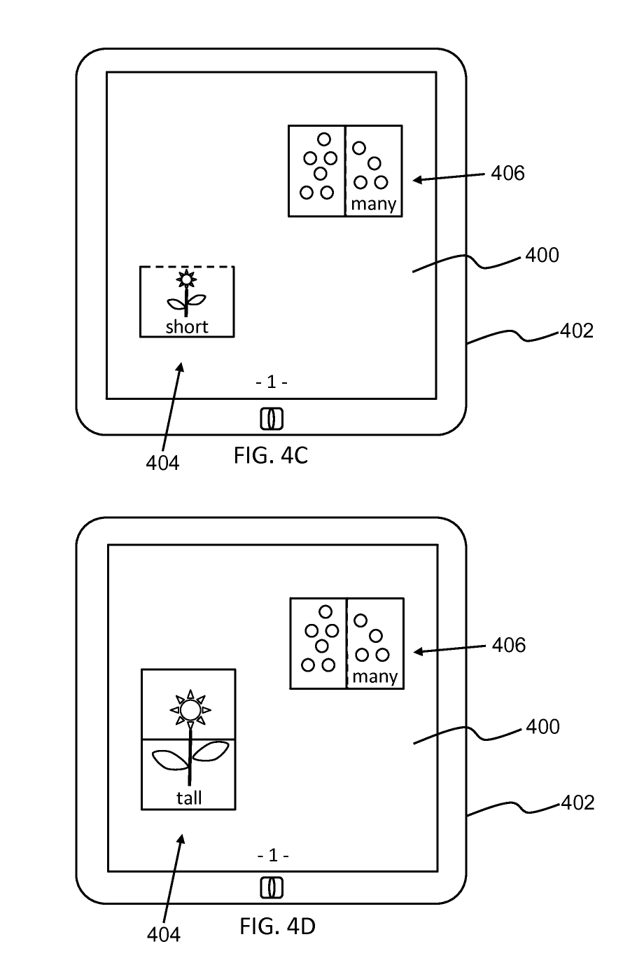

FIG. 4A is a simplified diagram of an electronic display device displaying first page image data relating to digital book content. The first page image data is displayed via display portion 400 of electronic device 402, and includes a first virtual flap 404 and a second virtual flap 406, each of the first and second virtual flaps being visually represented in a closed state. During use, when a user selects one of the first and second virtual flaps 404 and 406, respectively, the first page image data is replaced by other page image data. More particularly, when the user selects one of the first and second virtual flaps 404 and 406, respectively, in one of the closed state and an opened state, the other page image data is substantially identical to the first page image data except the selected one of the first and second virtual flaps 404 and 406, respectively, is shown in the other one of the closed state and the opened state.

FIG. 4B is a simplified diagram showing second page image data relating to the digital book content of FIG. 4A, subsequent to the user selecting the first virtual flap 404 in the closed state within the first page image data. In second page image data displayed in FIG. 4B, the first virtual flap 404 is visually represented in the opened state whilst the second virtual 406 flap continues to be visually represented in the closed state.

FIG. 4C is a simplified diagram showing third page image data relating to the digital book content of FIG. 4A, subsequent to the user selecting the second virtual flap 406 in the closed state within the first page image data. In the third page image data displayed in FIG. 4C, the second virtual flap 406 is visually represented in the opened state whilst the first virtual flap 404 continues to be visually represented in the closed state.

FIG. 4D is a simplified diagram showing fourth page image data relating to the digital book content of FIG. 4A, subsequent to the user selecting one of the first and second virtual flaps 304 and 306, respectively, in the closed state within one of the second and third page image data. In FIG. 4D, each one of the first and second virtual flaps 304 and 306 is visually represented in the opened state.

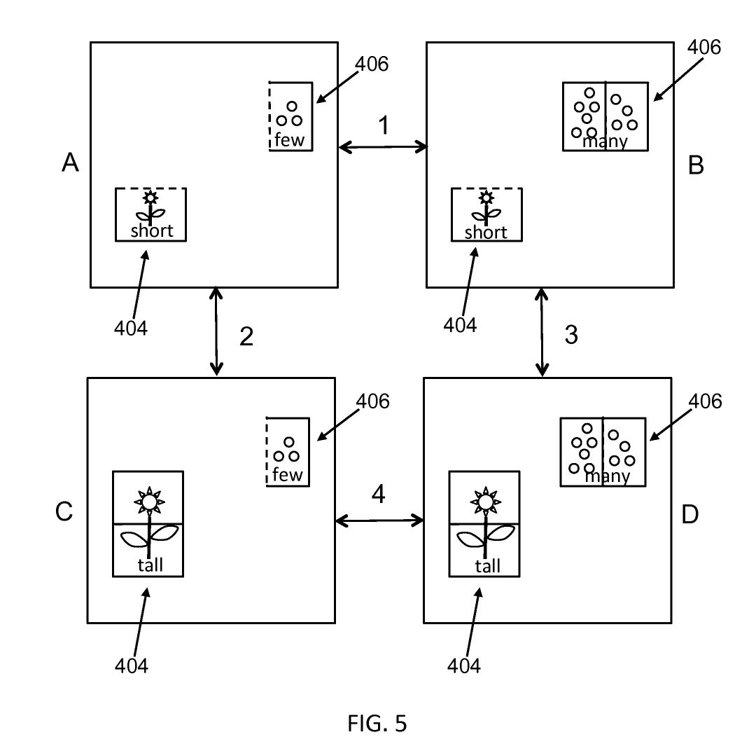

Referring now to FIGS. 4A-4C and to FIG. 5, a page of digital book content comprising N virtual flaps is defined, each one of the N virtual flaps having an opened state and a closed state. In addition, 2^{N} different page images relating to the same defined page of digital book content are provided and stored within a storage element in communication with the electronic device 402. More particularly, each one of the 2^{N} different page images is for visually representing the page of digital book content with the N virtual flaps arranged in a different combination of opened and closed states. To this end, mapping data is provided for switching between displaying a first page image of the 2^{N} page images and a second page image of the 2^{N} page images in response to a user selecting one of the N virtual flaps. Such mapping data is shown in a very schematic fashion in FIG. 5. For instance, initially first page image data denoted “A” is displayed in which the first virtual flap 404 and the second virtual flap 406 are visually represented in respective closed states. When the user selects the second virtual flap 406, then transition “2” occurs and second page image data denoted “B” is displayed in place of the first page image data. Alternatively, when the user selects the first virtual flap 404, then transition “3” occurs and third page image data denoted “C” is displayed in place of the first page image data. As shown in FIG. 5, there is no transition to support directly replacing the first page image data with fourth page image data denoted “D.” In other words, the mapping data that is shown schematically in FIG. 5 requires the user to “lift” one flap at a time. As such, the user may select the second virtual flap 406 from the display of the third page image data “C,” causing transition “4” to occur resulting in display of the fourth page image data “D.” Alternatively, the user may select the first virtual flap 404 from the display of the second page image data “B,” causing transition “3” to occur resulting in display of the fourth page image data “D.” Of course, each transition may be selected in the opposite direction simply by selecting one of the first and second virtual flaps 404 and 406, respectively, in the opened state. For example, selecting the first virtual flap 404 in the display of the fourth page image data “D” causes transition 4 to occur in the reverse direction and resulting in the display of the third page image data “C.” With sufficiently detailed mapping data, the opening and closing of a larger plurality of virtual flaps in any order may be simulated by displaying selectively an appropriate sequence of page image data. Optionally, displaying page image data includes displaying an animation simulating the lifting of a selected one of the plurality of virtual flaps.

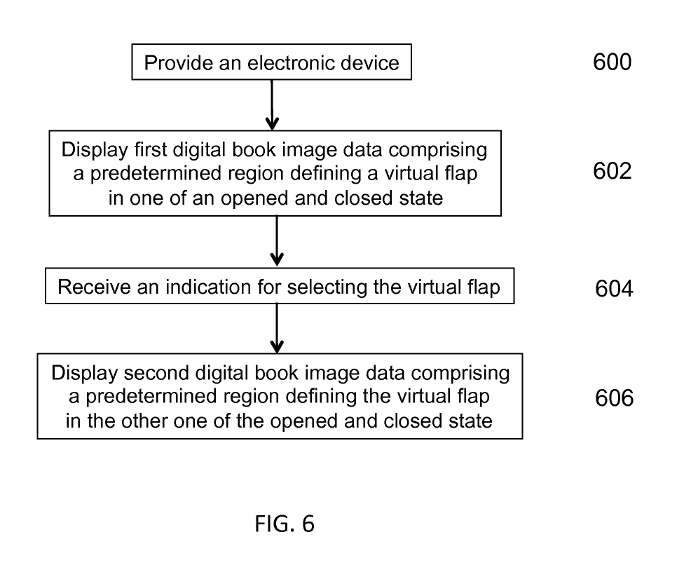

Referring to FIG. 6, shown is a simplified flow diagram of a method according to an embodiment of the instant invention. At 600 an electronic display device is provided. In particular, the electronic display device comprises a display portion, such as for instance a touch-sensitive screen. The display portion is for displaying digital book content to a user of the electronic display device. At 602 digital book content comprising first image data relating to a page of a digital book, and comprising a predetermined region defining a virtual flap, is displayed to the user via the display portion. In particular, the virtual flap is displayed within the predetermined region of the first image data in one of a closed state and an opened state. At 604 an indication is received from the user via the electronic display device, the indication for selecting the virtual flap that is displayed within the predetermined region of the first image data. At 606, in response to receiving the indication, second image data is displayed to the user via the display portion, the second image data relating to the page of the digital book and comprising a predetermined region defining the virtual flap, the virtual flap being displayed within the predetermined region of the second image data in the other one of the closed state and the opened state.

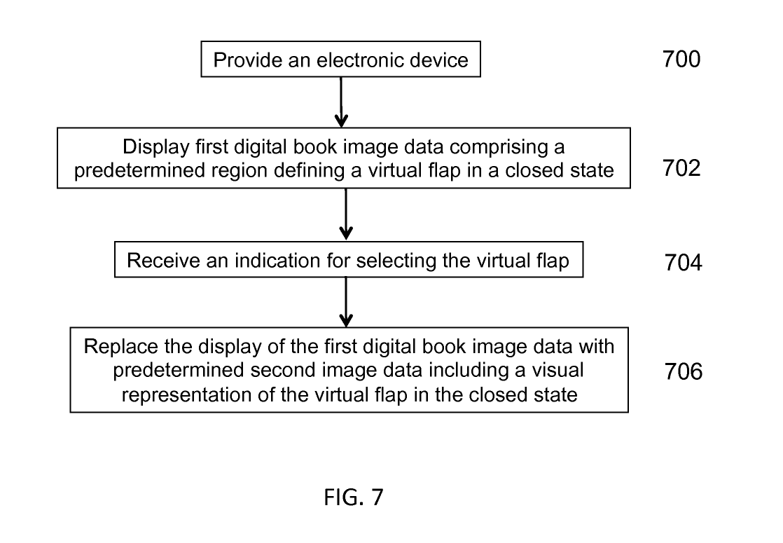

Referring to FIG. 7, shown is a simplified flow diagram of a method according to an embodiment of the instant invention. At 700 an electronic display device is provided. In particular, the electronic display device comprises a display portion, such as for instance a touch-sensitive screen. The display portion is for displaying digital book content to a user of the electronic display device. At 702 digital book content comprising first image data relating to at least a portion of a page of a digital book is displayed to the user, via the display portion. In particular, the at least the portion of the page of the digital book comprises a virtual flap. At 704 an indication for selecting the virtual flap is received from the user via the electronic display device. At 706, in response to receiving the indication, the display of the first image data is replaced with a display of predetermined second image data. In particular, the first image data provides a visual representation of the virtual flap in a closed state and the predetermined second image data provides a visual representation of the virtual flap in an opened state.

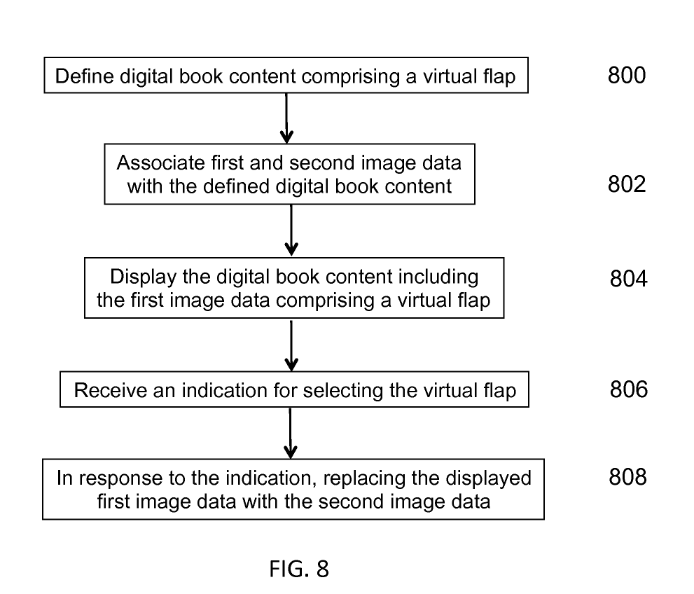

Referring to FIG. 8, shown is a simplified flow diagram of a method according to an embodiment of the instant invention. At 800 digital book content is defined for being displayed to a user via a display portion of an electronic display device, the digital book content comprising a virtual flap. At 802, first image data and second image data are associated with the defined digital book content, the first image data for providing a visual representation of the virtual flap in a closed state and the second image data for providing a visual representation of the virtual flap in an opened state. At 804 the digital book content is displayed to the user via the display portion of the electronic display device, which comprises displaying the first image data within a predetermined region of the digital book content. At 806 an indication is received from the user via the electronic display device, the indication for selecting the virtual flap. At 808, in response to receiving the indication from the user, the first image data displayed within the predetermined region of the digital book content is replaced with the second image data.

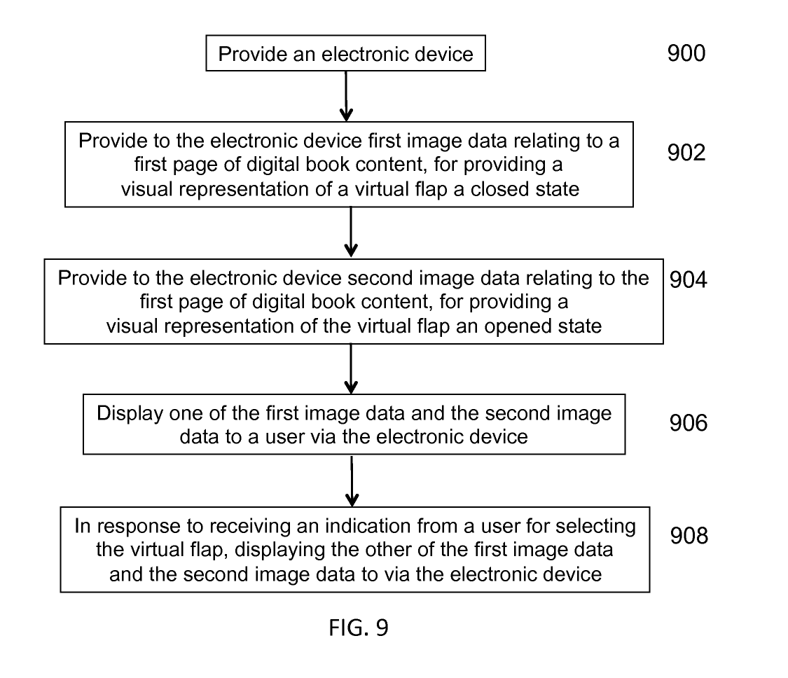

Referring to FIG. 9, shown is a simplified flow diagram of a method according to an embodiment of the instant invention. At 900 an electronic display device is provided comprising a display portion for displaying digital book content. At 902 first image data relating to a first page of digital book content is providing to the electronic display device, the first image data for providing a first visual representation of a virtual flap within a predetermined region of the first page of digital book content, the virtual flap being visually represented in a closed state. At 904 second image data relating to the first page of digital book content is provided to the electronic display device, the second image data for providing a second visual representation of the virtual flap within the predetermined region of the first page of digital book content, the virtual flap being visually represented in an opened state. At 906 one of the first image data and the second image data are displayed to a user via the display portion of the electronic display device. At 908, in response to receiving an indication from the user for selecting the virtual flap, the other one of the first image data and the second image data are displayed to the user via the display portion of the electronic display device.

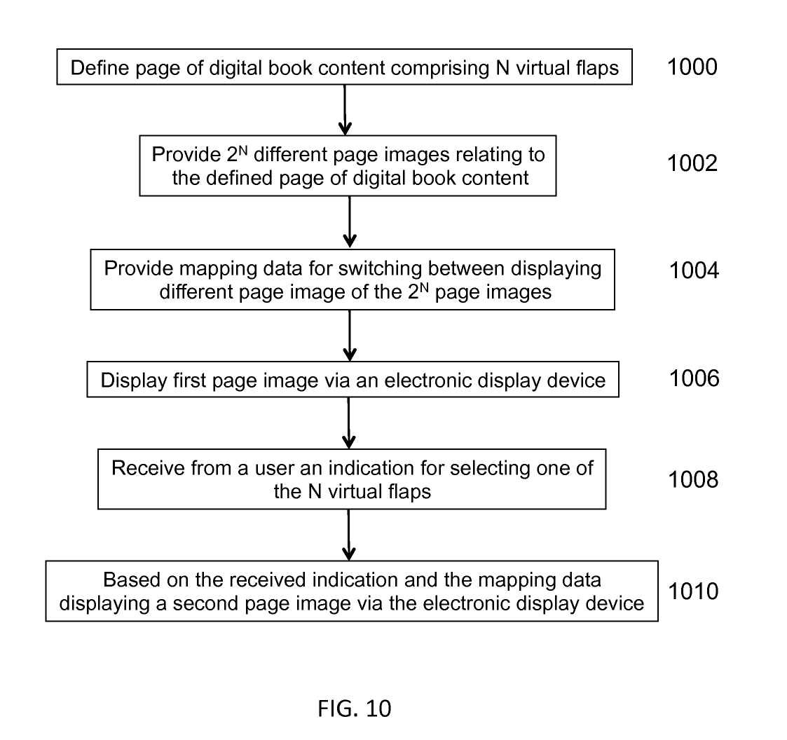

Referring to FIG. 10, shown is a simplified flow diagram of a method according to an embodiment of the instant invention. At 1000 a page of digital book content is defined, the page comprising N virtual flaps, each one of the N virtual flaps having an opened state and a closed state. At 1002, 2^{N} different page images are provided relating to the defined page of digital book content, each one of the 2^{N} different page images for visually representing the page of digital book content with the N virtual flaps arranged in a different combination of opened and closed states. At 1004 mapping data is provided for switching between displaying a first page image of the 2^{N} page images and a second page image of the 2^{N} page images in response to a user selecting one of the N virtual flaps. At 1006 the first page image of the 2^{N} page images is displayed via a display portion of an electronic display device. At 1008 an indication for selecting the one of the N virtual flaps is received from the user via the electronic display device. At 1010, based on the mapping data and the received indication, the second page image of the 2^{N} page images is displayed via the display portion. According to the method of FIG. 10, the selected one of the N virtual flaps is represented in one of the closed state and the open state in the first page image, and the selected one of the N virtual flaps is represented in the other one of the closed state and the open state in the second page image.

According to the methods described with reference to any one of FIGS. 6 to 10, optionally an animation simulating the lifting of a selected virtual flap is part of the step of displaying and/or replacing.

Numerous other embodiments may be envisaged without departing from the scope of the invention.

What is claimed is:

1. A method comprising:
providing an electronic display device comprising a display portion for displaying digital book content;
displaying to a user, via the display portion, digital book content comprising first image data relating to a page of a digital book and comprising a predetermined region defining a virtual flap, the virtual flap being displayed within the predetermined region of the first image data in one of a closed state and an opened state;
receiving from the user via the electronic display device an indication for selecting the virtual flap that is displayed within the predetermined region of the first image data; and,
in response to receiving the indication, displaying to the user, via the display portion, second image data relating to the page of the digital book and comprising a predetermined region defining the virtual flap, the virtual flap being displayed within the predetermined region of the second image data in the other one of the closed state and the opened state.

2. A method according to claim 1, wherein the predetermined region of the first image data and the predetermined region of the second image data are displayed within substantially a same display area of the display portion of the electronic display device.

3. A method according to claim 1, wherein displaying the second image data comprises displaying an animation of the virtual flap during transition thereof between the closed state and the opened state.

4. A method according to claim 1, wherein the display portion of the electronic display device comprises a touch-sensitive screen, and wherein receiving the indication from the user comprises sensing the user touching the touch-sensitive screen within the predetermined region of the first image data.

5. A method according to claim 4, wherein receiving the indication from the user comprises sensing at least one of a pinching-gesture and a swiping gesture made by the user within the predetermined region of the first image data.

6. A method according to claim 1, wherein the first image data comprises image data relating to an upper side of the virtual flap.

7. A method according to claim 6, wherein the second image data comprises other image data relating to a lower surface of the virtual flap and digital book content defined under the virtual flap.

8. A method according to claim 7, wherein the displayed second image data is different during different instances of displaying the second image data.

9. A method according to claim 8, wherein the second image data is selected from a plurality of predetermined second image data based on profile data associated with the user.

10. A method according to claim 7, wherein the second image data is selected from a plurality of predetermined second image data based on historical preference data provided by the user.

11. A method according to claim 7, wherein the second image data is selected from a plurality of predetermined second image data based on historical indication data provided by the user, the historical indication data relating to a sequence of selection of at least one other virtual flap of the digital book content prior to the indication of the selection of the virtual flap.

12. A method according to claim 6, wherein the second image data is selected from a plurality of predetermined second image data, each second image data of the plurality of second image data for providing a different visual representation of the virtual flap in the opened state.

13. A method comprising:
providing an electronic display device comprising a display portion for displaying digital book content;
displaying to a user, via the display portion, digital book content comprising first image data relating to at least a portion of a page of a digital book, the at least the portion of the page of the digital book comprising a virtual flap;
receiving from the user via the electronic display device an indication for selecting the virtual flap; and,
in response to receiving the indication, replacing the display of the first image data with a display of predetermined second image data,
wherein the first image data provides a visual representation of the virtual flap in a closed state and the predetermined second image data provides a visual representation of the virtual flap in an opened state.

14. A method according to claim 13, wherein the display portion comprises a touch-sensitive screen, and wherein receiving the indication from the user comprises sensing the user touching the touch-sensitive screen within a display area of the virtual flap.

15. A method according to claim 14, wherein receiving the indication from the user comprises sensing at least one of a pinching-gesture and a swiping gesture made by the user within the display area of the virtual flap.

16. A method according to claim 13, wherein replacing comprises superimposing the predetermined second image data on the first image data.

17. A method according to claim 13, wherein replacing comprises displaying the predetermined second image data in place of the first image data.

18. A method according to claim 13, wherein the predetermined second image data comprises an animation of the virtual flap during transition thereof between the closed state and the opened state, and wherein replacing comprises displaying the animation.

19. A method according to claim 13, wherein the first image data comprises image data relating to an upper side of the virtual flap.

20. A method according to claim 19, wherein the predetermined second image data comprises other image data relating to a lower surface of the virtual flap as well as digital book content defined under the virtual flap.

21. A method according to claim 20, wherein the displayed second image data is different during different instances of displaying the second image data.

22. A method according to claim 20, wherein the second image data is selected from a plurality of predetermined second image data based on profile data associated with the user.

23. A method according to claim 21, wherein the second image data is selected from a plurality of predetermined second image data based on historical preference data provided by the user.

24. A method according to claim 20, wherein the second image data is selected from a plurality of predetermined second image data based on historical indication data provided by the user, the historical indication data relating to a sequence of selection of at least one other virtual flap of the digital book content prior to the indication of the selection of the virtual flap.

25. A method according to claim 19, wherein the second image data is selected from a plurality of predetermined second image data, each second image data of the plurality of second image data for providing a different visual representation of the virtual flap in the opened state.

26. A method comprising:
defining digital book content for being displayed to a user via a display portion of an electronic display device, the digital book content comprising a virtual flap;
associating first image data and second image data with the defined digital book content, the first image data for providing a visual representation of the virtual flap in a closed state and the second image data for providing a visual representation of the virtual flap in an opened state;
displaying the digital book content to the user via the display portion of the electronic display device, comprising displaying the first image data within a predetermined region of the digital book content;
receiving from the user via the electronic display device an indication for selecting the virtual flap; and,
in response to receiving the indication from the user, replacing the first image data displayed within the predetermined region of the digital book content with the second image data.

27. A method according to claim 26, wherein the display portion of the electronic display device comprises a touch-sensitive screen, and wherein receiving the indication from the user comprises sensing the user touching the touch-sensitive screen within the predetermined region of the displayed digital book content.

28. A method according to claim 27, wherein receiving the indication from the user comprises sensing at least one of a pinching-gesture and a swiping gesture made by the user within the predetermined region of the displayed digital book content.

29. A method according to claim 26, wherein replacing comprises superimposing the second image data on the first image data.

30. A method according to claim 26, wherein replacing comprises displaying the second image data within the predetermined region in place of the first image data.

31. A method according to claim 26, wherein the second image data comprises an animation of the virtual flap during transition thereof between the closed state and the opened state, and wherein replacing comprises displaying the animation.

32. A method according to claim 26, wherein the first image data comprises image data relating to an upper side of the virtual flap.

33. A method according to claim 32, wherein the second image data comprises other image data relating to a lower surface of the virtual flap as well as digital book content defined under the virtual flap.

34. A method according to claim 33, wherein the displayed second image data is different during different instances of displaying the second image data.

35. A method according to claim 33, wherein the second image data is selected from a plurality of predetermined second image data based on profile data associated with the user.

36. A method according to claim 34, wherein the second image data is selected from a plurality of predetermined second image data based on historical preference data provided by the user.

37. A method according to claim 33, wherein the second image data is selected from a plurality of predetermined second image data based on historical indication data provided by the user, the historical indication data relating to a sequence of selection of at least one other virtual flap of the digital book content prior to the indication of the selection of the virtual flap.

38. A method according to claim 32, wherein the second image data is selected from a plurality of predetermined second image data, each second image data of the plurality of second image data for providing a different visual representation of the virtual flap in the opened state.

39. A method comprising:
providing an electronic display device comprising a display portion for displaying digital book content;
providing to the electronic display device first image data relating to a first page of digital book content, the first image data for providing a first visual representation of a virtual flap within a predetermined region of the first page of digital book content, the virtual flap being visually represented in a closed state;
providing to the electronic display device second image data relating to the first page of digital book content, the second image data for providing a second visual representation of the virtual flap within the predetermined region of the first page of digital book content, the virtual flap being visually represented in an opened state;
using the electronic display device, displaying to a user via the display portion one of the first image data and the second image data; and,
in response to receiving an indication from the user for selecting the virtual flap, displaying to the user via the display portion the other one of the first image data and the second image data.

40. A method according to claim 39, wherein the display portion of the electronic display device comprises a touch-sensitive screen, and wherein receiving the indication from the user comprises sensing the user touching the touch-sensitive screen within the predetermined region of the first page of digital book content.

41. A method according to claim 40, wherein receiving the indication from the user comprises sensing at least one of a pinching-gesture and a swiping gesture made by the user within the predetermined region of the first page of digital book content.

42. A method according to claim 39, wherein the first image data comprises image data relating to an upper side of the virtual flap.

43. A method according to claim 42, wherein the second image data comprises other image data relating to a lower surface of the virtual flap and digital book content defined under the virtual flap.

44. A method according to claim 43, wherein the displayed second image data is different during different instances of displaying the second image data.

45. A method according to claim 43, wherein the second image data is selected from a plurality of predetermined second image data based on profile data associated with the user.

46. A method according to claim 44, wherein the second image data is selected from a plurality of predetermined second image data based on historical preference data provided by the user.

47. A method according to claim 43, wherein the second image data is selected from a plurality of predetermined second image data based on historical indication data provided by the user, the historical indication data relating to a sequence of selection of at least one other virtual flap of the digital book content prior to the indication of the selection of the virtual flap.

48. A method according to claim 42, wherein the second image data is selected from a plurality of predetermined second image data, each second image data of the plurality of second image data for providing a different visual representation of the virtual flap in the opened state.

49. A method comprising:
defining a page of digital book content comprising N virtual flaps, each one of the N virtual flaps having an opened state and a closed state;
providing 2^{N} different page images relating to the defined page of digital book content, each one of the 2^{N} different page images for visually representing the page of digital book content with the N virtual flaps arranged in a different combination of opened and closed states;
providing mapping data for switching between displaying a first page image of the 2^{N} page images and a second page image of the 2^{N} page images in response to a user selecting one of the N virtual flaps;
displaying via a display portion of an electronic display device the first page image of the 2^{N} page images;
receiving from a user via the electronic display device an indication for selecting the one of the N virtual flaps; and,
based on the mapping data and the received indication, displaying the second page image of the 2^{N} page images via the display portion;
wherein the selected one of the N virtual flaps is represented in one of the closed state and the open state in the first page image, and the selected one of the N virtual flaps is represented in the other one of the closed state and the open state in the second page image.

50. A method according to claim 49, wherein the other ones of the N virtual flaps are represented in the same one of the open state and the closed state in both the first page image and the second page image.

51. A method according to claim 49, wherein providing the 2^{N} different page images and providing the mapping data comprises storing the 2^{N} different page images and storing the mapping data within a memory element of the electronic display device.

52. A method according to claim 49, wherein providing the mapping data comprises storing the mapping data within a memory element of the electronic display device and wherein providing the 2^{N} different page images comprises streaming page images of the 2^{N} different page images via a communication network, from a memory device that is remote from the electronic display device.

53. A method according to claim 49, wherein the display portion of the electronic display device comprises a touch-sensitive screen, and wherein receiving the indication from the user comprises sensing the user touching the touch-sensitive screen within a display area of the one of the N virtual flaps.

54. A method according to claim 53, wherein receiving the indication from the user comprises sensing at least one of a pinching-gesture and a swiping gesture made by the user within the display area of the one of the N virtual flaps.
